(19) United States
(12) Patent Application Publication
(10) Pub. No.: US 2023/0064900 A1
(43) Pub. Date: Mar. 2, 2023

(54) AIR FRYER LINER

(71) Applicant: Dorothy Ann Cooper, Richmond, VA (US)

(72) Inventor: Dorothy Ann Cooper, Richmond, VA (US)

(21) Appl. No.: 17/813,758

(22) Filed: Jul. 20, 2022

Related U.S. Application Data
(60) Provisional application No. 63/260,764, filed on Aug. 31, 2021.

(51) Int. Cl. A47J 36/02; A47J 37/06; A47J 36/16

(52) U.S. Cl. CPC A47J 36/022; A47J 37/0664; A47J 36/16; A47J 37/0641

(57) ABSTRACT

An air fryer liner of a unitary sheet of aluminum foil lining an interior of an air fryer inner basket including a circumferential liner floor with an outer edge positioned horizontally on a floor of the air fryer inner basket and liner walls extending vertically from the outer edge of the circumferential liner floor, covering walls of the air fryer inner basket.

### CROSS-REFERENCE TO RELATED APPLICATION

This application claims the benefit of priority of U.S. provisional application No. 63/260,764, filed Aug. 31, 2021, the contents of which are herein incorporated by reference.

### BACKGROUND OF THE INVENTION

The present invention relates to air fryers and, more particularly, to an air fryer liner.

When using an air fryer, the oil drips off of the food in the fryer and makes a mess. Oil can be very hard to clean. It is sticky and leaves discolorations. Soap does not always remove an oil mess. It often takes hard scrubbing, soaking, and expensive cleaners to remove oil messes.

As can be seen, there is a need for a device that prevents oil messes when using an air fryer.

### SUMMARY OF THE INVENTION

In one aspect of the present invention, an air fryer liner comprising a unitary sheet of aluminum foil lining an interior of an air fryer inner basket comprising a circumferential liner floor with an outer edge positioned horizontally on a floor of the air fryer inner basket and liner walls extending vertically from the outer edge of the circumferential liner floor, covering walls of the air fryer inner basket.

These and other features, aspects and advantages of the present invention will become better understood with reference to the following drawings, description, and claims.

### BRIEF DESCRIPTION OF THE DRAWINGS

FIG. 1 is a perspective view of an air fryer liner according to an embodiment of the invention shown in use;

FIG. 2 is an exploded top perspective view thereof;

FIG. 3 is an exploded bottom perspective view thereof;

FIG. 4 is a section view taken on line 4-4 of FIG. 1;

FIG. 5 is a section view of FIG. 4 with an inner basket removed from the air fryer; and

FIG. 6 is an exploded side view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a liner for an air fryer.

The liner for the air fryer may be composed of aluminum foil. Aluminum foil is durable and disposable. The liner may be disposable after use.

The liner lines an interior of an air fryer inner basket. The liner may catch oil that drips from the food into the air fryer. By catching oil, the liner reduces the need for cleaning the interior of the air fryer.

The liner may be cut to a custom size or shape to match the interior of the air fryer inner basket. It may line a floor of the air fryer inner basket and interior walls of the air fryer inner basket. The liner may also form a ceiling for the air fryer inner basket. The ceiling may be detachable from the walls and malleable to conform to the walls of the air fryer inner basket. When installing the ceiling liner, the ceiling may be folded or bent or molded to conform to the air fryer inner basket walls which support the liner ceiling.

The liner may be a unitary piece with a floor and walls. The floor may be circumferential and positioned horizontally on a floor of the air fryer inner basket. Liner walls of the liner may extend vertically from an outside edge of the circumferential liner floor. The liner walls may cover walls of the air fryer inner basket.

The liner may be perforated to encourage air flow in the air fryer when the air fryer is in operation. The perforations may be in the liner walls or in the liner ceiling. The perforations may range in size from 0.1 square inches to 1 square inch. The perforations be circular, oval, square, or rectangular. The perforations may be positioned in such a fashion to not deteriorate or compromise the integrity of the liner.

Once the liner has lined the interior of the air fryer inner basket, a food may be placed into the lining. The air fryer may then be operated to cook the food. Once the food has been cooked, the food may be removed from the liner. Alternatively, the liner containing the food may be removed from the air fryer inner basket. The liner may be disposed of or may be used to wrap the food. The liner may be used store the food in a refrigerator or a freezer.

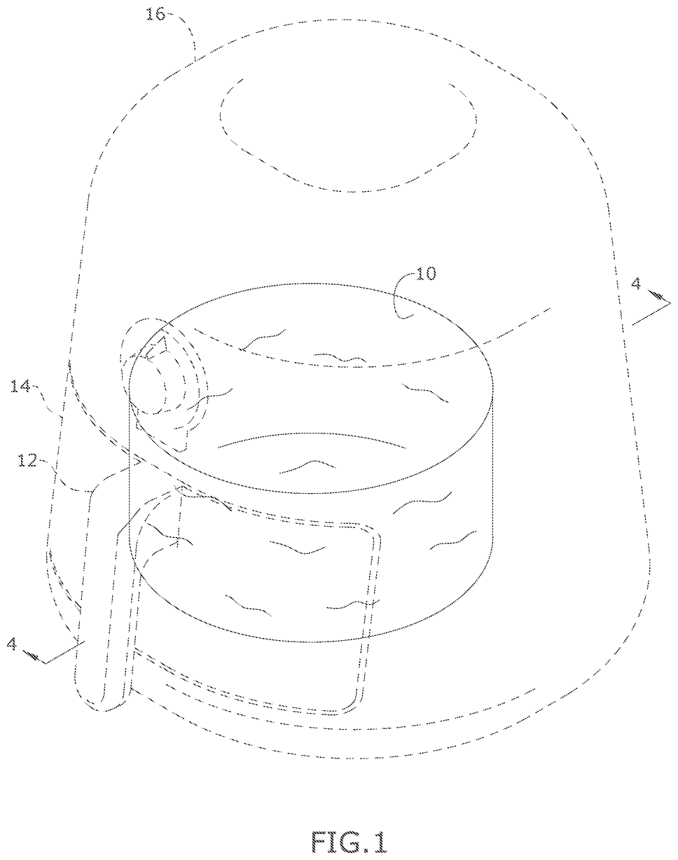

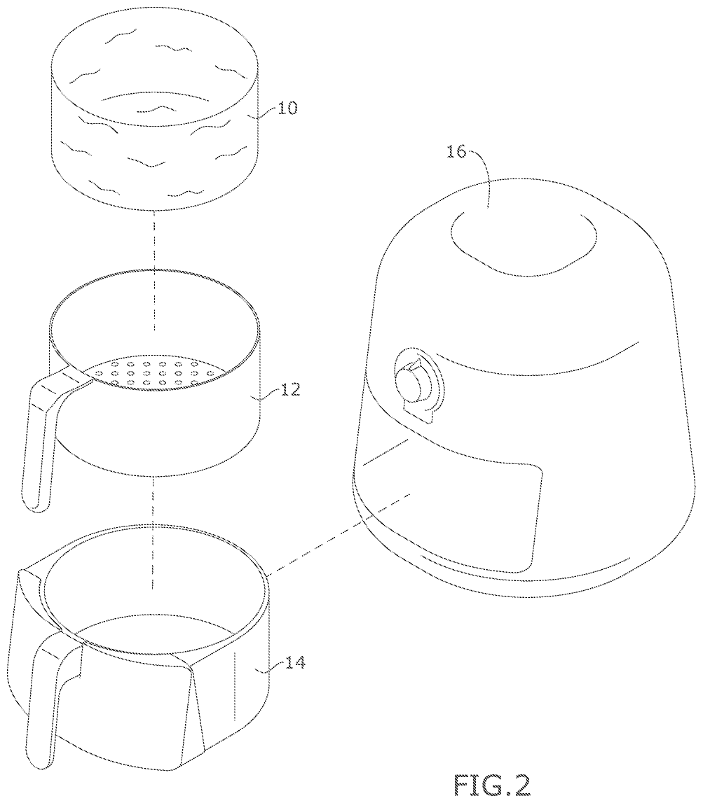

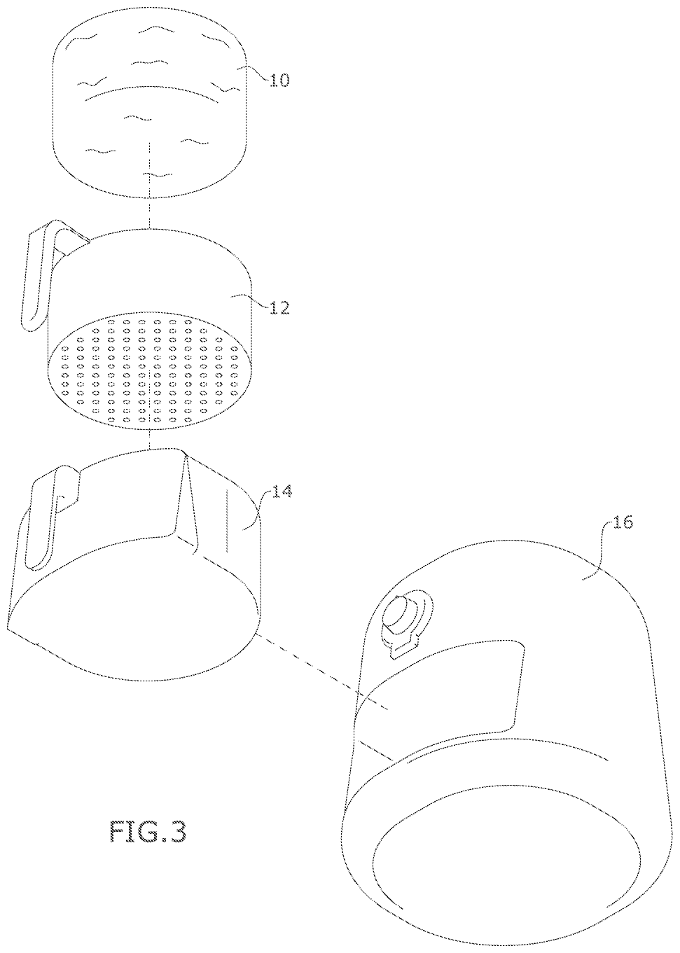

Referring now to the Figures, FIG. 1 through FIG. 3 depict an embodiment of an air fryer 16. An air fryer inner basket 12 rests in an air fryer outer basket 14 inside of the air fryer 16. The liner 10 lines an interior wall and an interior floor of the air fryer inner basket 12.

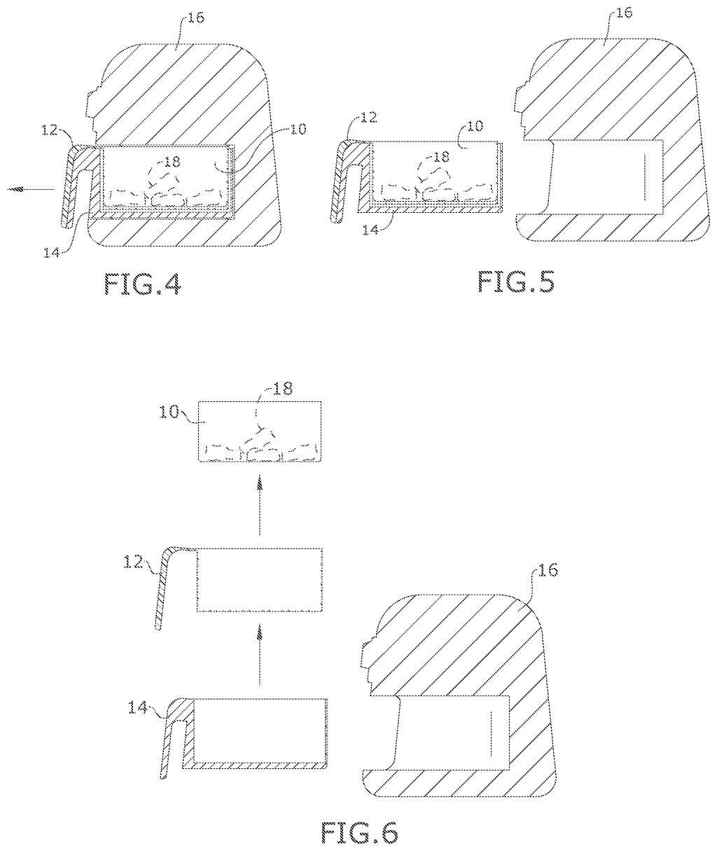

FIG. 4 through FIG. 6 show food 18 in the liner 10 of the air fryer 16 according to an embodiment of the present invention.

It should be understood, of course, that the foregoing relates to exemplary embodiments of the invention and that modifications may be made without departing from the spirit and scope of the invention as set forth in the following claims.

What is claimed is:

1. A air fryer liner comprising:
a unitary sheet of aluminum foil lining an interior of an air fryer inner basket comprising:
a circumferential liner floor with an outer edge positioned horizontally on a floor of the air fryer inner basket; and
liner walls extending vertically from the outer edge of the circumferential liner floor, covering walls of the air fryer inner basket.

2. The air fryer liner of claim 1, wherein the liner is disposable after use.

3. The air fryer liner of claim 1, wherein the liner walls are perforated.

4. The air fryer liner of claim 1, further comprising a detachable liner ceiling, wherein the detachable liner ceiling is malleable to conform to the walls of the air fryer inner basket.

5. The air fryer liner of claim 4, wherein the liner ceiling is perforated.
